(19) United States
(12) Patent Application Publication
(10) Pub. No.: US 2008/0259026 A1
(43) Pub. Date: Oct. 23, 2008

(54) ERGONOMIC CURSOR CONTROL DEVICE THAT DOES NOT ASSUME ANY SPECIFIC POSTURE OF HAND AND FINGERS

(75) Inventors: Leonid Zeldin, Moscow (RU); Cyrille Velikanov, Moscow (RU); Mikhail Klimov, Moscow (RU)

Correspondence Address: VELIKANOV CYRILLE, SIRENEVYL BOULEVARD 27, BLOCK 3, APT 84, MOSCOW, 105425, RU

(73) Assignees: Leonid Zeldin, Moscow (RU); Cyrille Velikanov, Moscow (RU); Mikhail Klimov, Moscow (RU)

(21) Appl. No.: 11/737,872

(22) Filed: Apr. 20, 2007

(51) Int. Cl. G06F 3/033

(52) U.S. Cl. 345/157

(57) ABSTRACT

An ergonomic mouse-like cursor control device is disclosed that does not assume any specific posture of hand and fingers. The device provides for freedom of hand's movements rather than supports the hand in a presumably best operative posture. As a result, a human operator can continuously use the inventive cursor control device during a long time without feeling discomfort or accumulating fatigue. In one preferred embodiment, the inventive device is a plate, e.g. of a rectangular form, with a slightly elevated border or rim. For a mouse-type operation of the device, the operator may place onto the plate from one up to all five fingers, while freely flexing, extending, expanding or tightening them at any time. The plate has pressure sensitive zones playing the role of traditional mouse buttons and scrolling wheel. Various other embodiments of the inventive device may differ in shape and in number of components.

### FIELD OF THE INVENTION

The present invention in general relates to cursor control devices that are part of, or used in conjunction with, table-top computers, laptop computers (notebooks) and other data handling systems that comprise a video display terminal with a movable on-screen pointer commonly called “mouse cursor” or simply “cursor”.

In a narrower context, the present invention relates to cursor control devices of a type commonly called “computer mouse” or simply “mouse”. A mouse is a small hand-operated object typically having a convex shape to be easily embraced by the palm or grasped by fingers of a user's hand, and whose movements on a flat working surface cause similar movements of the cursor on the display screen.

The problem addressed by the present invention is that of discomfort, accumulated fatigue and even corporal injuries to which the user's hand is exposed when manipulating a mouse of any conventional type during prolonged period of time. Several types of “ergonomic” computer mice have been proposed tackling this problem, which nevertheless still remains present and acute. The present invention proposes an ergonomic mouse-like device that solves the problem of hand fatigue in a most radical and definite way.

### BACKGROUND OF THE INVENTION

The problem of repetitive strain injury when using conventional computer mice

The majority of today's office workers in every branch of economy use computers several hours a day. Typical user interface of today's computer programs includes intensive use of a cursor control device; a mouse is by far the most widely used among various types of those devices. When manipulating a conventional computer mouse for several hours a day, users often experience significant discomfort in their hand, a feeling that accumulates not only during a single working session, but also day after day. In the course of time this accumulated discomfort and fatigue may even lead to physiological disorder that is known in the literature as Repetitive Strain (or Stress) Injury, abbreviated to RSI. More specifically, this phenomenon is termed “carpal-tunnel syndrome”; generally speaking, it is caused by constantly using the same hand posture, thus tensing the same muscles for a long period of time.

The large majority of “ergonomic” mice that have been proposed in the last years tackle the problem by creating more and more sophisticated mouse bodies, each of which is claimed to “support” the user hand in a yet more “natural” and “relaxed” position of function. The problem with those alternative mouse form factors is that, after some period of time during which the user typically feels some pain relief when using such a new mouse, the above-mentioned syndrome reappears as strong as it was before. Because of that, many alternative mice are commercially proposed at any given time, but none survives or gains momentum after some initial period of more or less active sales.

Almost every patent application in the field typically contains a large prior art section, where specific causes of carpal-tunnel syndrome are scrutinized and various proposed mouse form factors are criticized. Without entering into details, we simply refer to one such discussion, contained in the US Pat. Application No. 20050275621 by Saez et al., containing several further references to mouse designs having various form factors each claiming to “support” the user's hand better than others do.

The above cited document provides also a long citation from a notorious medical source, The Hand (1985) Vol. II, Chapter 53, published by W. B. Saunders Company. The best “position of function” of a human hand is described there in much detail, specifying positions and flexing angles of forearm, wrist, and every finger. Having described such an ideal position of function, the citation concludes, however, with the following important note:

“There does not exist a ‘position of function’ in immobility; the function of the hand necessarily involves movement.” The Hand, Vol. II, Chapter 53 at 501.

In other words, immobility of the hand or of some of its members causes unproductive tensions and efforts, hence fatigue. Any object of a fixed shape, forcing the hand to take always the same posture for its operation, is not “handy”. The key concept is not about “support”; it is about “freedom”. Strange enough, this concept of freedom, i.e. the possibility of freely changing the hand's posture as often as desired (and even unnoticeably) when operating a mouse, seems not to have attracted any attention of inventors and designers of ergonomic computer mice.

Why the majority of users prefer mice to other cursor control devices

There exist cursor control devices other than mice. Among those other device types, touch-pads are by far the most popular; devices like trackball or pin have very limited use because they require very small and precise finger movements. A touch-pad has become the mandatory component on all notebooks, and is also provided on some advanced keyboards. This type of cursor control device, however, has its own drawbacks from the ergonomic point of view. It is operated by a single finger (typically, the index) while the hand is suspended in the air with the other fingers permanently maintained in elevated position, thus accumulating fatigue. Alternatively, inoperative fingers may repose on the touch-pad edges. In this case, the operating finger (typically the index) performs unnatural lateral movements.

Other negative factors are of a more psychological nature. When using a touch-pad, a finger moves alone by gliding upon the touch-pad surface, instead of moving some other object. In contrast, the natural paradigm of any hand action is “taking an object and moving it as needed”, while any slipping means loss of control.

Also, friction of fingertips against a surface is naturally used for the sole purpose of apprehending the surface characteristics, and not for performing or indicating whatever action. Fingertips have extremely sensitive tactile receptors; hence, when slipping fingers along a surface, the operator's attention is inevitably diverted towards surface-probing signals coming from those receptors.

Therefore, it is preferable to interpose some object between the hand and the surface, so that movements of that object upon the surface indicate similar movements of the cursor on the display. This explains why most computer users prefer mice to touch-pads, and even connect a mouse to a notebook equipped with a touch-pad.

The problem to solve may therefore be formulated as follows: a mouse-type cursor control device is needed, that is, a device having a form of an object to be moved on a surface by an operator hand, wherein the shape of the object does not restrain natural movements of the hand and of every individual finger, and allows the hand to perform diversified movements for achieving the same result, including reflex movements that are not necessary to achieve the result but are of a nature to alleviate static muscular load and fatigue.

None of the prior art cursor control device solves this problem satisfactorily.

### OBJECT OF THE INVENTION

One object of the present invention is to provide a hand-operated mouse-type cursor control device that does not present a common disadvantage of any mouse-type device known in the prior art, the disadvantage which consists in forcing the operator's hand to remain mostly in the same working position when operating the device, thus causing discomfort, accumulated fatigue and even corporal injuries, in particular those known in the literature as “repetitive stress injury” (RSI) and “carpal tunnel syndrome”.

It is to be specially noted that, in the above definition of the object of the present invention, and elsewhere in the present invention disclosure, the expressions “mouse-type” or “mouse-like” are not to be understood as referring to the shape of any specific object commonly termed a “computer mouse”; but rather as referring to the main function of any such object, namely, to cause movements of a cursor on a display screen by moving the object on a working surface by the operator hand.

Accordingly, a more specific object of the present invention is to provide a hand-operated mouse-type cursor control device of such a shape and construction that it does not force or assume any specific position of function of the human operator's hand and of every its individual finger, even if such specific position is a priori considered as ergonomically preferable.

### BRIEF SUMMARY OF THE INVENTION

In accordance with the present invention, a mouse-type cursor control device is provided that can be operated by placing fingertips of the operator's hand (typically from two to four, or all the five digits) on its upper side and sliding the whole device along any suitable working surface, such as a table top surface or a mouse pad.

In order to achieve the foregoing objects and advantages of the present invention, the upper surface of the inventive device may consist of one common generally flat “finger support area” which is large enough for accommodating from one to for fingertips of the operator hand (or even all the five including the thumb) without restraining their position relative to each other. This single finger support area may be delimited by a slightly elevated “rim” to prevent fingers from sliding out and to give the user more natural feel. Friction force between fingertips and the finger support area should be greater than between the bottom side of the device and the working surface it is sliding on.

In another embodiment of the inventive device, its upper surface presents a number of oblong “grooves” with elevated elastic “rims” between adjacent grooves, in a way that fingers placed into those grooves may take any position relative to each other, by placing every fingertip at appropriate place in the appropriate groove and stretching or tightening those elastic rims between grooves as necessary. The whole upper surface of the device may therefore be seen as a flexible goffered plate. The elastic force should preferably be small enough in order not to impose significant efforts to the operator fingers.

Alternatively, the goffered plate may be made pliable in a way to remain in the last state used after removing any finger effort from it. In this way, the same device may take any desired shape and maintain it as long as it is felt comfortable, and then change the shape at the operator's will.

Yet another embodiment of the inventive device has separate slightly elongated finger support alveoles or “troughs” for accommodating individual fingertips. Wires or ties between troughs may be flexible or deformable as in the above embodiment; these may link adjacent troughs, or, alternatively, they may link all the troughs to a distinct forebody part of the device, where e.g. the device motion detector may be placed.

In yet another embodiment of the inventive device, one-finger troughs are linked to a forebody part by using rigid or slightly resilient wires or ties that end with flat ring-shaped spacers on a common axis within the forebody. These spacers may turn relative to each other around their common axis. The whole stack of spacers may be tightened to such a degree as to create some friction factor between their adjacent surfaces, that is perceptible when the user's fingers expand or get closer in order to change relative positions of the troughs.

Finally, a variation of the above embodiment is proposed based on the same friction principle, where troughs are threaded on a rigid or slightly flexible wire or other slider.

Disposition and realization of the customary mouse controls (typically the left and the right button and the scrolling wheel) may be done in various ways in the inventive device. A number of miniature pressure sensors may be mounted beneath the upper surface of the device within the limits of the appropriate finger support area or areas. By pressing or tapping a finger support area at any place, or at a specific place where a sensor is mounted, the corresponding “left button” or “right button” signal may be generated in the same way as in any conventional computer mouse.

In the embodiment with a single multi-finger support area, there may be two distinct pressure sensitive zones, performing the functions of the “left button” and the “right button” respectively. These zones may have visible or tactile markings of any kind, easily recognizable by the user. Some embodiments may even have more than two such zones, thus providing for enhanced functionality.

In the embodiment with several one-finger support areas (“grooves”), some or each of those grooves may be provided with a pressure sensitive zone, every zone performing specific function or functions. As in the single-area embodiment, more than two distinct sensitive zones may be installed thus providing for enhanced functionality. Alternatively, sensitive zones in neighboring grooves may have the same functionality, e.g. in a four-groove device the grooves for the index and middle fingers may play the role of the left button, while the grooves for the ring and little fingers may play the role of the right button.

The function of the classical scrolling wheel may be assigned to a special oblong pressure sensitive zone with several sensors ranged along its axis. This zone may be located e.g. between the zones corresponding to the left and right button functions; in the embodiment with one-finger grooves, the scrolling function may be assigned e.g. to the middle-finger groove. Scrolling up and down may then be performed by gently pressing the scrolling zone by a finger and gliding the finger along the scrolling zone in appropriate direction.

In another embodiment, the scrolling function may be assigned to the thumb and implemented e.g. as a scrolling wheel located on top or on appropriate side of a protuberance area of the device where for example the device electronic components (and also a battery in a wireless device) may be located.

As for the transmission of signals from the inventive device to the computer or other data processing device, this can be equally implemented using a wire connection or wirelessly. All the proposed embodiments can implement both wireline and wireless connection, as would do most of the other possible embodiments.

Yet another solution consists in making a passive mouse-type device whose movements are detected by an external active part, e.g. of a digitizer tablet type. This solution may be used with each one of the above embodiments of the inventive device; in this case, the onboard motion sensor will be replaced with an externally detectable passive element.

### BRIEF DESCRIPTION OF DRAWINGS

FIG. 1 depicts the first preferred embodiment of the inventive device, with one multi-finger support area having three pressure sensitive zones, resp. for the functions of the left button, the scrolling wheel and the right button. Two orthogonal cross-sections of the device are shown on the bottom of the figure.

FIG. 2(a) depicts an alternative embodiment of the inventive device that has a form of a goffered plate with several single-finger “grooves” (four-groove device is shown). The optional protuberance area on the left side of the device serves to accommodate the device electronics and power supply battery if needed (not shown), and may also be equipped with a scrolling wheel or other scrolling device manipulated by the user's thumb. FIGS. 2(b), (c) and (d) show operator's hand placed in different positions on the inventive device.

FIG. 3 shows another alternative embodiment of the inventive device, with several single-finger “troughs” (four-trough device is shown). The troughs are linked pairwise by two flexible ties or wires, and then the two pairs are linked between them by a third flexible tie or wire passing through a “forebody”. Cross-sections of one trough are shown on the bottom of the figure, as well as on the bottom of the two subsequent figures.

FIG. 4 shows yet another alternative embodiment of the inventive device, differing from the previous embodiment in that each of the four troughs is individually linked to the forebody of the device by a rigid or slightly resilient wire or tie that ends with a flat ring-shaped spacer. These spacers may turn relative to each other around their common axis within the forebody. The whole stack of spacers may be more or less tightened in a way to select the desired friction factor between their adjacent surfaces.

FIG. 5 shows a yet different alternative embodiment of the inventive device, with four troughs being “threaded” onto a rigid or semi-rigid two-wire support, on which they are maintained by friction force, in a way to provide for easy changes in the device's “initial working configuration” to accommodate it e.g. to different hand sizes.

### DETAILED DESCRIPTION OF THE INVENTION

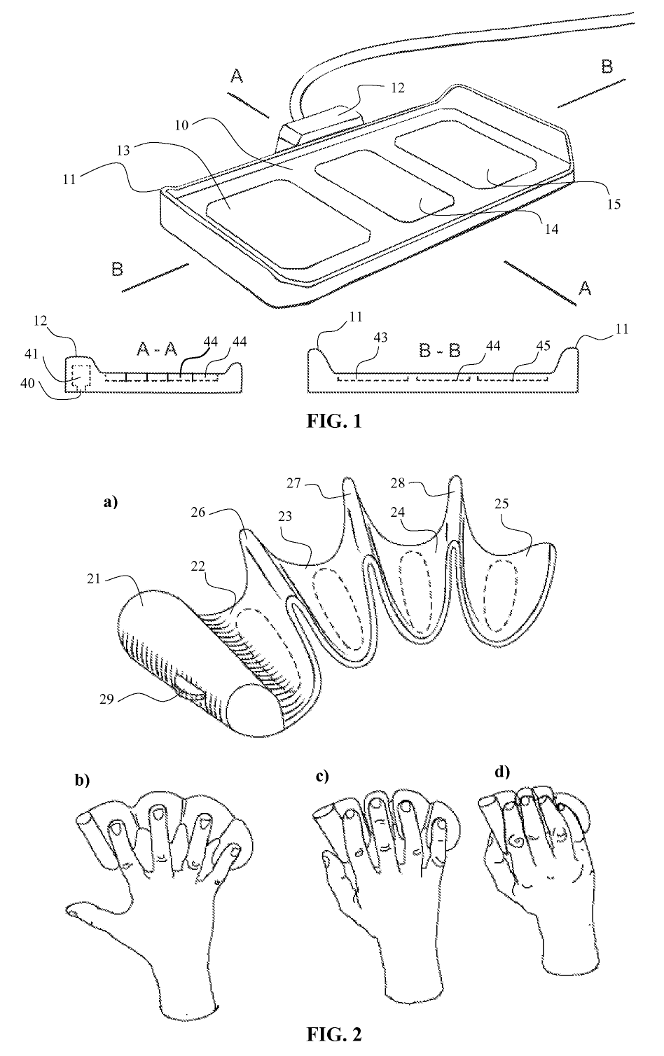

With reference to the attached FIGS. 1 to 5, five different embodiments of the present invention will now be described in detail, with their minor variations also being mentioned. From this detailed description of various proposed embodiments of the invention, a person skilled in the art may easily devise many other embodiments and their variations, without departing from the scope and spirit of the invention.

Of the five embodiments described herein, the second and the fifth are shown on the attached Figures as wireless devices, while the first, the third and the fourth exhibit a wire connection to the computer or another data handling device. In fact, any one of the five described embodiments may be implemented as wireless or wire-connected.

### First Embodiment

With reference to the attached FIG. 1, a first embodiment of the present invention will be now described. On FIG. 1, a mouse-type cursor control device is shown having a shape of a generally flat plate with a slightly elevated border or rim 11. The general view is accompanied with the A-A and B-B cross-sections of the device. The whole upper surface of the device presents one multi-finger support area 10 large enough for accommodating up to four fingers of user's left or right hand, or even all the five fingers including the thumb.

Typically, however, the user will place only three fingers on this support area, namely the index, the middle finger and the ring finger, while hanging the thumb and the little finger in the air, or placing one or both of them on the rim 11, or else, firmly placing them on the working surface at both sides of the device in order to achieve more precise small movements of the device by the longer three fingers.

The inventive device shown on FIG. 1 has a generally rectangular form elongated from left to right, for keeping its size quite small while still accommodating all the three longer fingers and optionally also the little finger and/or the thumb.

The inventive device bears a motion detector 40, preferably of optical type because of its compactness. This motion detector may be placed anywhere on the bottom side of the device; on FIG. 1 it is located within a jut 12 in the midst of the rear side of the device, that is, in front of the typical position of the middle finger. The same jut may optionally accommodate the necessary electronics 41. Other locations for the motion detector may equally be considered, without departing from the scope and the spirit of the invention. The device may bear on its upper surface a visible marking of the motion detector's location (not shown). This optional marking may be relief or painted, or it may be an active element such as LED (light-emitting diode).

On FIG. 1, the bordering rim of the finger support area is higher along the left and right sides. Such elevated sides are useful for gripping the device with the thumb and e.g. the little finger in order to carry it to another location without moving the cursor on the screen.

The device shown on FIG. 1 also has three pressure-sensitive zones, of which the left zone 13 corresponds to the left button on an ordinary mouse, the right zone 15 corresponds to the right button, and the narrower middle zone 14 performs the scrolling function. In this embodiment, the left zone 13 and the right zone 14 are each equipped with just one pressure sensor beneath the upper surface of the device, resp. 43 and 45, while the middle scrolling zone 14 has several sensors 44, preferably three or more, placed along the front-to-back axis B-B of the zone and of the whole device.

The left and the right zones may be used exactly as the two buttons on traditional mice, namely by clicking with a fingertip anywhere within the corresponding zone, or by pressing on the zone and maintaining the pressure while moving the device. These actions may optionally be accompanied by a mechanical and/or audible “click” as on some modern mice with “virtual buttons”.

The left zone 13 and the right zone 15 are both sufficiently large to accommodate e.g. the little finger together with the ring finger, or, if needed or desired, the thumb together with the index. The device as shown is symmetrical, and may therefore be interchangeably used by the right hand and by the left hand.

Using the same device by both the left-handed and the right-handed operators is facilitated by the same width of the zones 13 and 15. A right-handed operator would typically place both the ring finger and the little finger on the zone 15, while placing only the index on the zone 13. Inversely, a left-handed operator would typically place the ring finger and the little finger on the zone 13, while placing only the index on the zone 15.

The narrower middle zone 14 performs the scrolling function when gently pressing it with a fingertip, e.g. with the middle finger, and then moving the finger back or forth within the zone while maintaining the same pressure. This movement is translated into a sequence of elementary pressure actions on individual pressure sensors the middle zone is equipped with, or on groups of those sensors, and the resulting sequence is then analyzed for defining the direction, the length and the speed of scrolling.

Such a scrolling action may be performed by moving the middle finger within the middle zone while keeping the mouse immobile by other fingers, e.g. by the index and the ring finger placed directly onto the finger support area left and right of the middle zone. This will have an effect of simultaneously pressing both the left and the right buttons, but this effect may be interpreted by the device logic as pressing neither of them.

The pressure-sensitive zones 13 to 15 may be distinctively colored, or delimited by contour lines; also they may have rugged surface for their tactile recognition. For example, zones 13 and 15 may be made rugged, and the middle zone 14 may have smooth surface, or vice versa. In this way the user would recognize the limits of every zone without looking at the device.

### Options and Variations of the First Embodiment

It is to be noted that the rectangular form of the device as shown on FIG. 1 is not mandatory, neither is the elevated border of the device. Any generally flat device of any form, e.g. a circle or an ellipse, with or without bordering rim, which is suitable for freely accommodating operator fingers in any desired positions relative to each other, and which is provided with a motion detector of any kind, may be considered an embodiment of the present invention.

The whole multi-finger support area 10 needs not to be perfectly flat. For example, some or each of the pressure-sensitive zones 13 to 15 may be made slightly concave for their easy tactile recognition, or they may have slightly convex borders for the same purpose. Any such modification of the inventive device may be made without departing from the scope and spirit of the present invention, provided that the relief of the multi-finger support area 10 remains low enough, for the fingers of the operator's hand being still able to take any naturally acceptable position.

The scrolling zone 14 may alternatively be equipped with just two pressure sensors, the upper one and the lower one, and tapping or pressing on the upper or lower portion of the zone 14 (with the mouse cursor located anywhere on the screen) may then be interpreted as traditional clicking or pressing on the upper or lower arrow of the scroll-bar with the left button 13.

The left and right zones 13 and 15 may have their functions mutually switched if desired when using the device with the left hand instead of the right hand. This function switching may be done in software, or alternatively by a miniature hardware switch located directly on the device.

The three pressure-sensitive zones as shown on FIG. 1 are not a mandatory feature of the inventive device, which may alternatively have only two of them, for the left and the right button functions respectively. In this case, the scrolling function may be implemented as a classical scrolling wheel (not shown), installed e.g. on the upper side of the jut 12. More generally speaking, the inventive device may be equipped with any reasonable number of pressure-sensitive zones in any geometrical configuration, and specific functions may be assigned to those zones in the same way as described elsewhere for prior art multi-button mice.

In particular, miniature pressure-sensitive zones or other finger-actuatable controls may be located on the rim 11, esp. on its left and right sides, to be used with the thumb and/or with the little finger (not shown).

### Second Embodiment

Four alternative embodiments of the present invention will now be described with reference to FIGS. from 2 to 5 respectively.

The second embodiment is shown on FIG. 2a. FIGS. 2b to 2d show typical positions of an operator hand on the device. The inventive device is implemented here as a goffered plate, with its upper surface presenting a succession of four oblong “grooves” (22 to 25), with elevated elastic “rims” (26 to 28) separating adjacent grooves. Every groove accommodates one finger, from the little finger on the right to the index on the left; the device is hence asymmetric, presented here in a right-handed version.

On the left of the index groove there is a bolster 21 for placing the thumb on it; this bolster may accommodate electronic components of the device, and also a power supply battery in a wireless version of the device, as the one shown on FIG. 2. The motion detector may be placed on the bottom side of the bolster, or alternatively on the bottom side of the index groove or middle finger groove.

The rims 26, 27 and 28 separate adjacent grooves. They are made elastic, with the elastic force small enough in order for the fingers to freely expand or get closer to each other. In this way, the operator's hand and fingers can take any desired position on the device, with every finger being individually flexed or extended within the corresponding groove, and the angles between fingers being made larger or narrower by applying very small lateral effort to the elastic rims between grooves.

In addition, the operator may “grip” one or more elastic rims between adjacent fingers in order to inoperatively carry the device over the working surface.

Some or each of the grooves 22 to 25 may be equipped with pressure-sensitive zones implementing traditional mouse button functions. Every zone may occupy the bottom of the corresponding groove, and needs not to be visibly marked (dashed lines on FIG. 2a are only indicative of possible limits of the corresponding zones). For example, such zones may be installed in the grooves 22 and 24 only, that is, under the index and the ring finger, to be used resp. as the left and the right mouse button. The bottom of the groove 23 may be equipped, as described above for the preferred embodiment, with a multi-sensor pressure-sensitive zone to be used as a scrolling control with the middle finger.

Alternatively, a scrolling control may be installed on the upper or lateral surface of the bolster 21, to be operated by the thumb, and may take form of another pressure-sensitive zone or of a scrolling wheel (this latter option is shown on FIG. 2a and marked ‘29’). In this case, the groove 23 (and also 25) may still be equipped with pressure-sensitive zones that double the functions of the grooves 22 and 24, or perform supplementary functions (examples of such supplementary mouse functions are described elsewhere in prior art disclosures, and are not the object of the present invention).

The rims between grooves may be made perfectly resilient, or (at least partly) pliable. If they are made resilient, then the device has an “initial” or “default” shape, and takes this shape each time when the operator's fingers are taken off, or when they apply no force to the lateral walls of the grooves. This initial shape however should not be considered as the “preferred” or the “common” one, because the operator's hand can almost effortlessly adjust it to a desired hand position by stretching or tightening those elastic rims between grooves as necessary.

Making the rims pliable is an interesting option that may be felt preferable by many users. In this case, the inventive device has no “initial” shape. When the operator expands or gets closer the fingers thus applying lateral force to the walls of the grooves, the rims get larger or narrower; then, when the operator takes the hand off, the device remains in its last shape taken when in operation. In this way, the operator may use the inventive device in its current shape for as long as it is felt comfortable, and then change at will the disposition of the grooves.

The above-described embodiment illustrated on FIG. 2 admits many options and variations that can be introduced without departing from the scope and spirit of the present invention. For example, it may have only two or three grooves and may have no bolster. A three-groove, two-rim device with a pressure-sensitive zone at the bottom of each groove may be used as follows: the grooves are occupied by the index, the middle finger and the ring finger respectively; the index performs the left button function, the ring finger performs the right button function, and the scrolling function is performed by the middle finger using a multi-sensor zone at the bottom of the middle groove. The thumb and the little finger are in the air when performing large cursor movements, and may also be set against the working surface on the left and on the right of the device when performing precise cursor positioning. Such a three-groove device may be made symmetric, to be interchangeably used by both left-handed and right-handed persons.

### Three other Embodiments

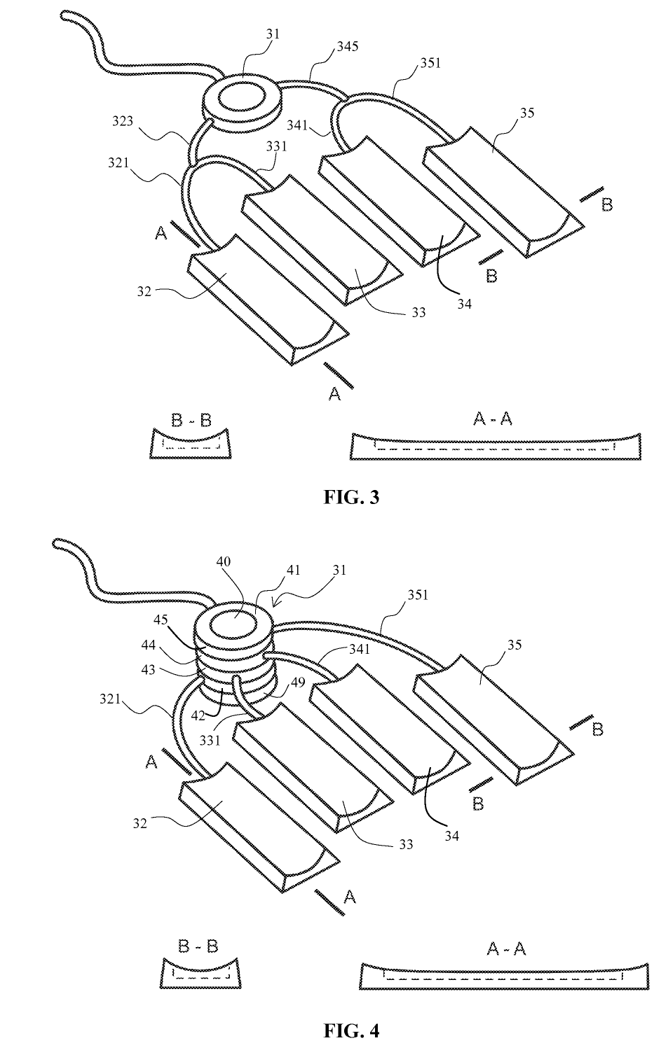

FIG. 3 shows yet another embodiment of the inventive device. It consists of four separate oblong alveoles or “troughs”, 32 to 35, each trough accommodating one fingertip, from the index to the little finger. Some or all of the four troughs are equipped with pressure sensitive zones, in the same way and with the same operational alternatives as described above for the grooves of the first alternative embodiment. These pressure sensitive zones are schematically delimited with dashed lines on the two cross-sections shown on the bottom of FIG. 3.

The troughs are linked pairwise by elastic ties, resp. 321-331 and 341-351, and the two pairs are further linked to a forebody 31 by the elastic tie 323-345 (on FIG. 3 it is shown as crossing the forebody 31). The forebody 31 may house a motion detector, and also electronic parts of the device and a power supply in a wireless version (not shown on FIG. 3). It is to be specially noted that in this embodiment, if the motion detector is located in the forebody 31, the motion detector is not tied in a rigid way to finger support areas 32 to 35; thus, lateral movements of troughs by operator fingers may result in small displacements of the forebody that would be registered by the motion detector.

All or some of these ties may provide for signal transmission from the pressure-sensitive zones in the troughs to the forebody. For example, a signal from pressure-sensitive zone in the trough 32 may follow the path 321-323 up to the forebody 31, and then continue toward the computer via a wire, as shown on FIG. 3, or wirelessly, in another possible variation of the embodiment.

All or some of the elastic ties 321-331, 341-351 and 323-345 may be made resilient or pliable, and all considerations of the above-described embodiment of FIG. 2 apply here as well, including the disposition of pressure-sensitive zones at the bottom of the troughs. On the bottom of FIG. 3 are shown two cross-sections of a trough with a pressure-sensitive plate at the bottom (schematically shown with dashed lines).

A symmetric three-trough device is also conceivable, that has no trough for accommodating little finger. Yet another possibility would be a “minimalist” two-trough device to be operated by the index and the middle or ring finger, where the scrolling function may be implemented e.g. by moving the device itself while simultaneously pressing both the left and the right trough zones.

The ties 321-331 and 341-351 may be implemented as two thin spring wires as shown on FIG. 3, linking resp. the trough 32 to 33 and 34 to 35. The third tie 323-345 may be welded onto the first two wires at their midst, thus linking together all the four troughs, and linking all them to the forebody 31.

FIG. 4 shows yet another alternative embodiment of the inventive device. Here, the same four troughs 32 to 35 are individually linked to the forebody 31, so that their respective ties 321 to 351 all enter the forebody 31, with no intermediate ties 323-345 that were used in the previously described embodiment. In the present embodiment, each of the ties 321 to 351 ends with a spacer, resp. 421 to 451, and all these spacers are spindled on a common axle 40 within the forebody 31, in such a way that they may be turned relative to one another around the axle 40. As each of the four troughs 32 to 35 shall remain in touch with the working surface, their bottom sides shall be in the same plane, provided that the working surface is flat. Therefore, the ties 321 to 351 shall be curved to different levels in vertical direction.

All the four spacers may be tightened between two nuts or bolt heads 41 and 49. In this way, the user may select a “default shape” of the device by spacing the troughs as desired and then tightening the spacers with the two nuts. Further flexibility of the device when in use will result from flexibility of the ties 32 to 35 implemented as spring wires.

Another variation, or another use of the above described construction with spacers on an axle, consists in using friction force to assure malleability of the device. This may be done by only weakly tightening the spacers, in a way as to allow the operator fingers to easily spread apart or get closer, together with the troughs under the fingers. Friction force would however maintain the same shape of the device when no lateral effort is applied to troughs by operator fingers. In this variation of the present embodiment, it is not necessarily for the ties 32 to 35 to be flexible.

Signals from the pressure-sensitive zones of the troughs will pass via their respective ties to the spacers, and from the spacers to the axle 40, to be finally sent to the computer along the wire (as shown on FIG. 4) or wirelessly (not shown). In order to insulate those signal paths between adjacent spacers, every spacer may e.g. have an inner conductive layer between two outer insulation layers; or, it may have a conductive path on its top surface that is touching the insulated bottom surface of the next spacer above. The axle itself should have a conductive ring (or just a ring sector) at the level of every spacer, and these conductive rings should be mutually insulated, each one connected to its own signal path within the axle.

The above succinct description of a possible construction of signal-passing axle 40 is provided here as an example only. Any other method, known in the art, of passing several signals from rotating parts of a device via their common axle to the outside of the device may be used here as well.

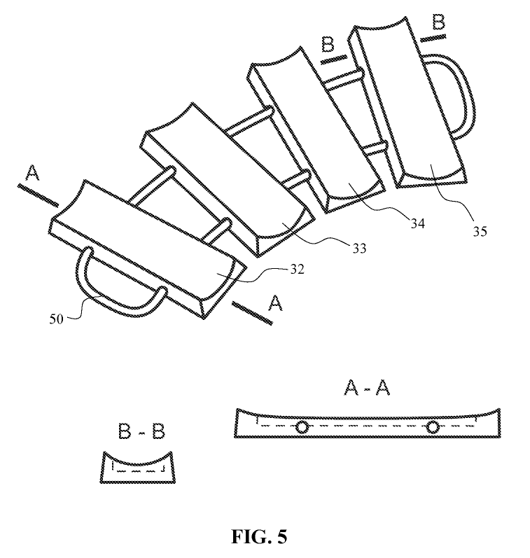

Finally, FIG. 5 shows an embodiment of the inventive device having the same four troughs 32 to 35 “threaded” onto a rigid or semi-rigid two-wire support 50, on which they are maintained by friction force, in a way to provide for easy changes in the device's “initial working configuration” to accommodate it e.g. to different hand sizes. FIG. 5 also provides two cross-sections of every trough (or, at least, of every trough having a pressure-sensitive zone, shown in dashed lines). The A-A cross-section also shows two holes for passing the two wires.

Although the holes are shown round, and the two-wire support 50 is shown as forming a closed loop, these are not mandated by the present invention. The support 50 may in fact have one, two or more parallel wires, interconnected or not, and having any particular cross-section. The only desired feature (though not absolutely mandatory, neither) is to maintain all four troughs within the same plane, provided that the working surface is flat.

Onboard electronic (or opto-electronic) components may either be located all within the same trough, e.g. the trough 32, or distributed between two or more troughs; in the latter case, electrical (or optical) signal passing should be provided between at least some of the troughs. In particular, the latter option is implied if the device is equipped with two or more pressure sensitive zones, located on distinct troughs. To make those components interoperate, the two-wire support 50 should have electric conductive paths along the wire surface, the conductive paths being in touch with their responding contact parts within the holes. Such an arrangement of conductive path may be easily designed in various ways according to prior art, and is not among the subjects of the present invention. It is therefore not shown nor described here in details.

Wireless signal transmission and other technological options

The following considerations apply to each of the five above described embodiments of the present invention, and may also apply to many other among its possible embodiments.

First, any of the above described embodiments can implement either wire or wireless connection to the data-handling device. For example, the attached Figures illustratively show the second and the fifth embodiments as wireless, while the first, the third and the fourth embodiments are shown with a wire or cable connecting the inventive device to a computer or like.

In a wireless case, the inventive device typically would have not only a wireless signal transmitter, but also an onboard power supply element, e.g. an accumulator battery, for powering all those onboard electronic, radio-electronic and/or opto-electronic components. The battery and the transmitter may be located in a most prominent or voluminous area of the device, e.g. in the jut 12 of the first embodiment; in the bolster 21 of the second embodiment; or, in the forebody 31 of the third or the fourth embodiment. As for the fifth embodiment, where all the troughs are of the same size, the transmitter and one or more batteries can be distributed among troughs together with other necessary electronics.

An RFID-type component that is wirelessly energized to generate wireless response signals may also be used, in order to eliminate the need of onboard power supply. RFID (Radio Frequency Identification) technology is an already mature and well-known technology that is used in various applications elsewhere. Alternatively, the necessary (quite small) amount of electrical energy may be generated by onboard solar cells, or by transforming mechanical energy of operator fingers pressing on the device, or by any other known technology.

Yet another alternative consists in providing a passive or semi-passive device that does not generate any signal by itself; instead, an external detection system, incorporated e.g. in a working surface such as digitizing tablet or like, may detect precise position of a passive component mounted on the inventive device. Such position detection may be based on mechanical, optical, electric, magnetic or any other principle, while still fully conforming to the scope and the spirit of the present invention.

Then, it should be noted that using pressure sensors is by no means mandatory for equipping the inventive device with finger controls similar to ordinary mouse buttons and scrolling wheel. Other physical phenomena may equally be exploited for detecting slight finger pressure against a surface; we may cite, without limitation, electrical capacitance or inductance sensors, optical sensors, heat sensors etc.

One may even consider detecting not a finger pressure but a simple finger touch, e.g. by a heat detector; or, detecting a finger presence in a given area, e.g. by an optical sensor. In this context, “pressure sensitive zones” in the above descriptions should be replaced by “presence detection zones” or like.

It should be emphasized that implementing the inventive device with the use of any of the above-cited technologies, or of any other signal generation and transmission technology, should not be considered by itself as departing from the scope and spirit of the present invention, provided that the device still possesses ergonomic qualities set forth in the present invention disclosure and formally specified in the appended claims.

Yet another variation or enhancement of the inventive device consists in equipping it with any kind of sensors that sense position of the operator fingertips relative to each other, or the fact of changing that relative position, and in generating appropriate signals to the computer or other data handling device, where those signals may be interpreted as specific user commands.

For example, the rims between grooves in the second above-described embodiment may bear strain sensors that detect operator's effort or action of getting closer the index and the middle or ring finger, and the appropriate signal may be interpreted by the computer e.g. as the action of “taking” an object under the mouse cursor (e.g. “copying” or “cutting” a currently selected object on the screen). Touch-pads or digitizers implementing this principle are known in the prior art; the present invention, however, applies it to the case when operator's fingers change the shape of some physical object, or make some effort to do it, rather than just freely moving themselves. The paradigm of specifying some action by changing the shape or position of some physical object has been already discussed above.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A cursor control device having a top side for placing thereon a human operator's fingers and a bottom side in contact with a working surface for sliding the device in any desired direction, said sliding motion of the device being detected by at least one motion detector that generates motion signals and conveys them to a data handling system provided with a display screen, causing corresponding movements of the cursor on the display screen,
wherein the top side of the device comprises at least one finger support area, said finger support areas allowing, by their shape and their disposition relative to each other, any physiologically acceptable and comfortable operative position of an operator's hand and fingers,
whereby a human operator can continuously use the cursor control device during a long time while changing operative position of the hand and fingers as often as desired or even unnoticeably, without feeling discomfort or accumulating fatigue.

2. The cursor control device of claim 1, wherein at least some of said finger support areas have a surface greater than is necessary for accommodating one fingertip, allowing for a finger placed thereon to move in at least one of the following directions: fingertip axial movements when flexing or extending a finger, and fingertip lateral movements when expanding or getting closer adjacent fingers, said movements performed by operator hand within its physiologically acceptable and comfortable limits.

3. The cursor control device of claim 2, having a finger support area for placing any combination of the index, middle and ring fingers, and optionally also the little finger and the thumb.

4. The cursor control device of claim 1, wherein the difference in slip factors for the bottom side of the device against the working surface and for fingertips against said finger support areas is such that operatively sliding the device along a typical working surface, such as an office table top, is possible at a relatively small pressure of the hand, without creating fatigue or discomfort.

5. The cursor control device of claim 1, wherein at least some of said finger support areas are at least partially bordered by prominences that limit movements of fingertips within appropriate bordered areas at least in some directions.

6. The cursor control device of claim 1, wherein at least some of said finger support areas are non-rigidly tied between them, said ties slightly resisting to deformation efforts applied by fingers placed on their respective finger support areas, the ties being such as, without limitation and in any combination:
resilient ties deformable by slight finger effort, and returning to reference position when no effort is applied;
pliable ties deformable by slight finger effort, and remaining at least partly deformed when no force is applied, the deformation being reversible by applying force in a substantially opposite direction;
mechanical ties comprising parts being maintained by friction force in a given configuration, said configuration being reversibly changeable by applying slight finger effort,
whereby operator fingers placed on their respective said non-rigidly tied finger support areas can spread apart or get closer without substantial effort.

7. The cursor control device of claim 6, wherein the upper side of the device presents a succession of grooves and of non-rigid prominences between adjacent grooves, every said groove serving as said finger support area and being elongated in the direction of movement of a fingertip when flexing or extending a finger placed into said groove, every said prominence providing said non-rigid tie between adjacent grooves,
thereby making it possible to operatively sliding the device across a working surface by placing a hand on it in any position being felt as comfortable, and to inoperatively elevating and carrying the device over the working surface by gripping at least one of said prominences with the fingers placed into the adjacent finger support areas.

8. The cursor control device of claim 6, comprising a plurality of parts, at least some of said parts providing said finger support areas, said parts being attached to one another by said non-rigid ties,
the ties being such as, without limitation and in any combination, a spring wire, a rigid wire, a rod, a strip,
the attachments of the extremities of said ties to the corresponding said parts being such as, without limitation and in any combination, a rigid attachment, an articulated attachment of a tie to a part, a coaxal articulation of a plurality of ties.

9. The cursor control device of claim 8, wherein one of said parts is a forebody to which at least some of said parts are attached by said non-rigid ties, the forebody optionally comprising a fastening mechanism to maintain said ties in a given configuration.

10. The cursor control device of claim 8, wherein, for at least some of said parts, their respective finger support areas have a form of an optionally oblong alveole.

11. The cursor control device of claim 6, wherein said non-rigid ties between finger support areas are operator-configurable for achieving a comfortable reference configuration prior to operating the device,
whereby further changes in disposition of finger support areas may be achieved, when operating the device, by slight finger efforts applied to finger support areas in said reference configuration.

12. The cursor control device of claim 1, further comprising at least one finger-actuatable control, each said finger-actuatable control responsive to specific actions of at least one finger and generating signals conveyed to said data handling system, the signals and possibly their combinations intended to indicate specific actions on the display screen such as, without limitation, establishing a cursor position, selecting an object, dragging an object, invoking a contextual menu, scrolling an image within a display window, performing copy, cut and past operations on objects.

13. The cursor control device of claim 12, wherein at least some of said finger-actuatable controls are responsive to specific actions of the operator fingers within some designated sub-areas of their respective finger support areas, said sub-areas being optionally marked for their visual recognition, said sub-areas being also optionally marked for their tactile recognition by presenting surface elements such as, without limitation and in any combination, an alveole, a bump, a rugged surface region, said finger actions being such as, without limitation and in any combination:
slight pressure of fingers against the top surface of the device within said sub-areas;
slight movements of appropriate fingers in appropriate directions, the fingers touching the top surface of the device within said sub-areas;
placing appropriate fingers within said sub-areas.

14. The cursor control device of claim 12, wherein at least some of said finger-actuatable controls are moving parts of the device, such as, without limitation, a wheel, a belt, a button, a toggle.

15. The cursor control device of claim 12, wherein at least some of said finger-actuatable controls are responsive to changing positions of appropriate fingers relative to each other, the fingers placed within their respective finger support areas and performing movements such as, without limitation, spreading apart, drawing closer, flexing, extending.

16. The cursor control device of claim 15, wherein at least some of the finger support areas are flexibly tied between them, and said movements of fingers relative to each other have an effect on said flexible ties and possibly cause displacements of the respective finger support areas relative to each other.

17. The cursor control device of claim 1, wherein said at least one motion detector is non-rigidly tied to at least some of said finger support areas.

18. The cursor control device of claim 1, having more than one said motion detector, wherein movements of motion detectors relative to each other and to the working surface are interpreted by said data handling system as indicating specific actions on the display screen such as, without limitation, establishing a cursor position, establishing a vector direction, turning an object around an axis.

19. The cursor control device of claim 1, wherein said at least one motion detector is external to the moving body of the cursor control device, performing contactless detection of the moving body displacements relative to the motion detector.

20. The cursor control device of claim 1, wherein conveying signals to said data handling system is done by such means as, without limitation, data cable, radio frequency, infrared, ultrasonic.
